(19) United States
(12) Patent Application Publication
(10) Pub. No.: US 2011/0294099 A1
(43) Pub. Date: Dec. 1, 2011

(54) SYSTEM AND METHOD FOR AUTOMATED ANALYSIS AND DIAGNOSIS OF PSYCHOLOGICAL HEALTH

(76) Inventor: Patrick K. Brady, Glen Ellyn, IL (US)

(21) Appl. No.: 13/116,778

(22) Filed: May 26, 2011

Related U.S. Application Data
(60) Provisional application No. 61/396,457, filed on May 26, 2010.

(51) Int. Cl. G09B 19/00

(52) U.S. Cl. 434/236

(57) ABSTRACT

A method and apparatus for automated analysis of emotional content of speech for discovery and assistance in early diagnosis of stress-related psychological health (PH) related issues is presented. Further, methods and apparatus for evaluation of treatments for PH disorders are also presented. Telephony calls are routed via a network such as a public service telephone network (PSTN) and delivered to an interactive voice response system (IVR) where prerecorded or synthesized prompts guide the caller to speech responses. The caller is led through a self-report questionnaire used by psychological professionals to identify stress-related disorders. These speech responses are analyzed for emotional content in real time or collected via recording and analyzed in batch. This data may be included in multi-dimensional databases for analysis and comparison to other collected patient data. Analysis may be performed to either increase the effectiveness of diagnosis (post confirmation) or evaluate the effectiveness of treatment regimes.

### CROSS-REFERENCE TO RELATED APPLICATIONS

This application claims priority to U.S. Provisional Patent Application Ser. No. 61/396,457, filed on May 26, 2010, titled “Method for Automated Analysis and Diagnosis of Psychological Health” the contents of which are hereby incorporated by reference in their entirety.

### BACKGROUND OF THE INVENTION

1. Field of the Invention

The present invention deals with methods and apparatus for automated analysis of emotional content of speech in the diagnosis and treatment of psychological health (PH) disorders.

2. Discussion of the State of the Art

Methods for determining emotional content of speech are beginning to come to market. Several providers of such systems provide for analysis of speech streamed from digitized sources such as pulse-code modulated (PCM) signals of telephony systems. Many applications of emotional content analysis (ECA) involve caller contact where it is desirable to automate the interaction. It is desirable for large corporations or government entities to utilize such a system for early diagnosis and treatment effectiveness measurement of PH disorders such as Post Traumatic Stress Disorder (PTSD). Current methods for diagnosis start with self-reporting questionnaires and typically involve time with a professional psychologist. This is a time-consuming and expensive process that can only be applied after a wealth of symptoms is typically already present in an individual. This can be a serious problem since suicide risk is a symptom of PH disorders.

There is a great need for an inexpensive and automated tool for diagnosing stress-related disorders. At present, diagnosis costs are too high to be practical for periodic assessments. Organizations with high stress jobs require ongoing assessment to catch employees as their stress levels reach dangerous limits. An inexpensive and automated method for diagnosis is needed to monitor levels of stress in an individual over time through periodic assessment. The results of this invention will make people more productive and, in fact, literally save many lives through instigating early treatment.

### SUMMARY OF THE INVENTION

The present invention seeks to provide an apparatus and method for automating Emotional Content Analysis (ECA) in telephony applications for diagnosis or assessment of stress-related PH disorders. There is thus provided, in accordance with a preferred embodiment, apparatus for receiving and processing calls, apparatus for storing and playing pre-recorded or synthesized prompts and for storing speech responses, apparatus for interconnecting computers and apparatus for performing ECA. There is also provided mechanism for administering self-report questionnaires as prompted voice applications for collection of responses for stress analysis.

In a typical application, calls are routed via a network such as a PSTN to an IVR system. Calls are answered and a greeting prompt is played. A caller answers questions from a questionnaire by speaking after prompts. In one preferred embodiment this speech is stored in a file. In a preferred embodiment, these files are moved in batch during off hours for ECA processing on another server. Naming and handling of such files is managed by software that is part of the Automated ECA System (AES). Data collected from ECA work is assembled into reports by an AES.

In another preferred embodiment, calls routed by a PSTN are delivered to an IVR system which has real time ECA technology capability. In this embodiment ECA is performed on prompt responses. Results are then immediately available for call processing within the IVR. In a simple example this might mean playing one of two follow-up prompts depending on an ECA result. In a more sophisticated application, ECA results may be used in conjunction with expert system technology to cause unique prompt selection or prompt creation based on a current context of caller, inference engine results and ECA results. In this embodiment ECA data would become part of a knowledge base and clauses to an inference engine would be made based on ECA states obtained from analysis.

In one preferred embodiment, an ECA host computer may be separate from an IVR. This is desirable as a way to either reduce real time processing load on the IVR, or as a way of controlling the software environment of the IVR system. The latter is a common issue in hosted IVR platforms such as those offered by Verizon or ATT. In another preferred embodiment an ECA host computer receives its voice stream by physically attaching to a telephony interface. Session coordination information is then passed between an IVR host and an ECA host (if necessary) to properly coordinate an association between calls and sessions in both machines.

### BRIEF DESCRIPTION OF THE DRAWING FIGURES

FIG. 1 is a block diagram showing systems and their interconnections, according to an embodiment of the invention.

FIG. 2 is a more detailed view of processes and their interconnections as related to a Voice Response Unit (VRU—another name for IVR) and its surrounding systems, according to an embodiment of the invention.

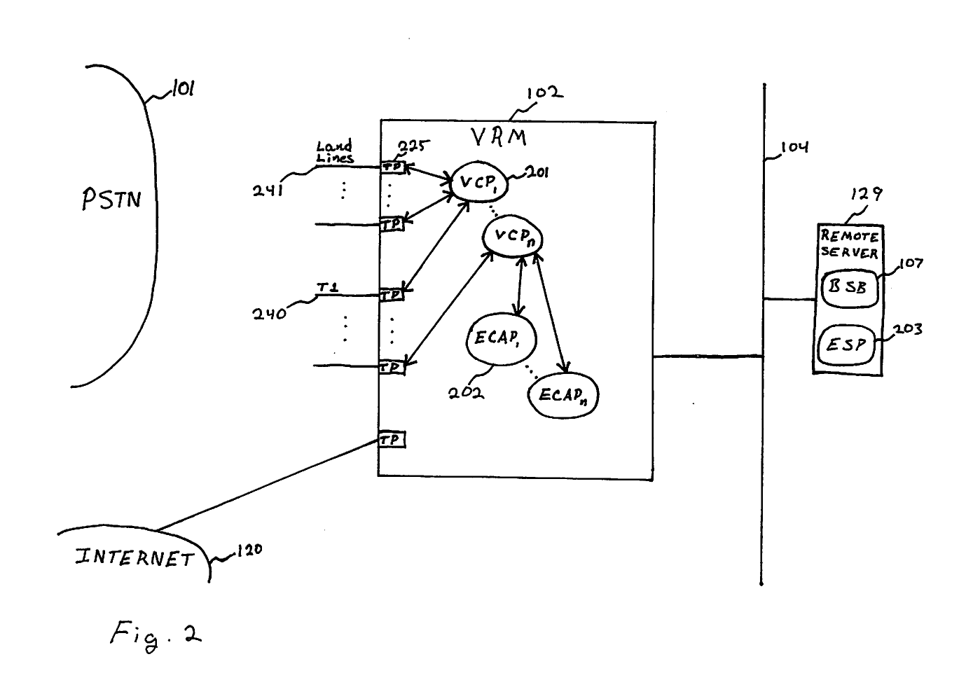

FIG. 3 is a diagram showing functional processes of an embodiment of the invention, and their intercommunication links.

FIG. 4 is a diagram showing ECA processes hosted in a separate server, according to an embodiment of the inventions.

FIG. 5 is a diagram showing ECA processes in a batch mode hosted on a separate server from an VRU, according to an embodiment of the inventions.

FIG. 6 shows interprocess messages and their contents, according to an embodiment of the inventions.

FIG. 7 shows PH initial screening and deep screening populations, according to an embodiment of the inventions.

FIG. 8 shows stress levels for a subject over time, according to an embodiment of the inventions.

FIG. 9 shows treatment effectiveness as expressed by ECA readings, according to an embodiment of the inventions.

### DETAILED DESCRIPTION

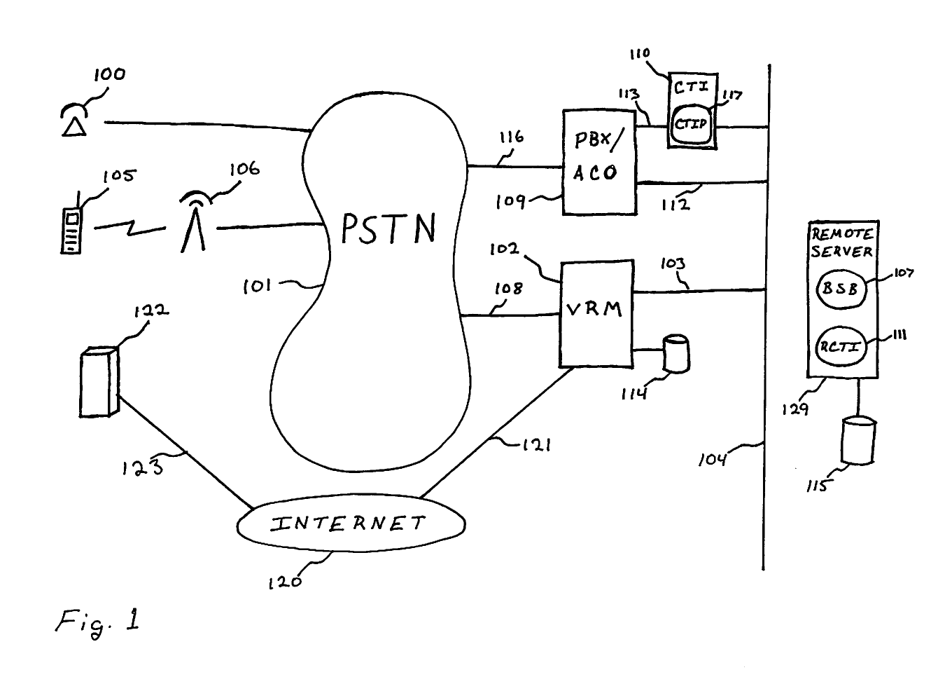

FIG. 1 shows calls originating from various telephony technology sources such as telephone handsets 100 connected to a Public Switched Telephone Network (PSTN) 101 or the Internet 120. These calls are routed by an applicable network to voice response unit (VRU) 102. A preferred embodiment discussed below describes land line call originations and PSTN-connected telephony connections such as T1 240 or land line 241 although any other telephony connection would be as applicable, including internet telephony.

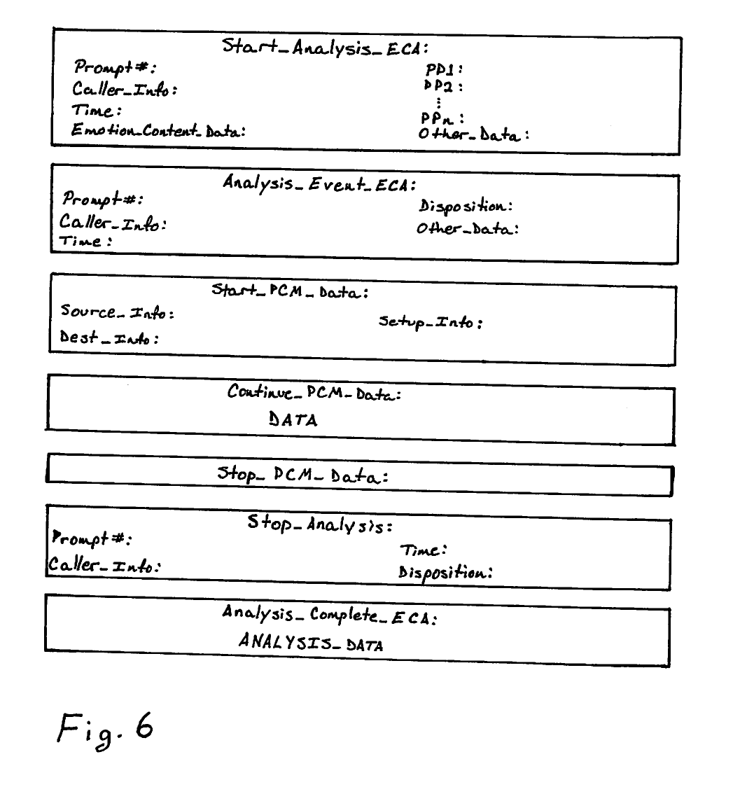

Once routed, calls appear at VRU 102 where they are answered by a VRU Control Process 201 (VCP) monitoring and controlling an incoming telephony port 220. Caller information may be delivered directly to telephone port 220 or obtained via other methods known to those skilled in the art. In a preferred embodiment caller speech is analyzed in real time. VCP 201 is logically connected to an Emotion Content Analysis Process 202 (ECAP) whereby a PCM stream (or other audio stream) of an incoming call is either passed for real time processing or identification information of a hardware location of a stream is passed for processing. In any case, VCP 201 sends a START_ANALYSIS message (as described in FIG. 6) to ECAP 202 telling it to begin analysis and giving it data it needs to aid in analysis such as Emotional Context Data (ECD). This data may be used by ECAP to preset ECA algorithms for specific emotional types of detection. For instance, keywords such as “Emotional pattern 1” or “Emotional pattern 2” can be used to set algorithms to search for the presence of patterns from earlier speech research for an application.

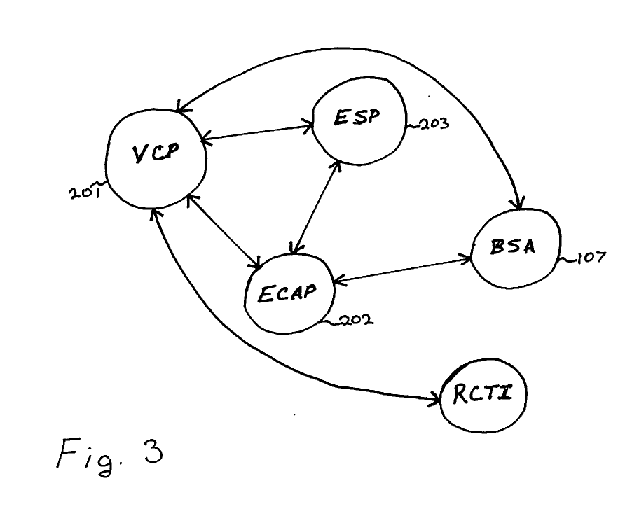

After receipt of this message, ECAP begins analysis of the caller audio in real time. ECD may be used in an ECA technology layer to provide session-specific context to increase accuracy of emotion detection. ECA analysis may generate ECA events as criteria are matched. Such events are reported to other processes, for instance, from ECAP 202 to VCP 201 via ANALYSIS_EVENT_ECA messages (as described in FIG. 6). FIG. 3 shows other processes with reporting relationships to ECAP 202. These relationships may be set up at initialization or at a time of receipt of an START_ANALYSIS_ECA message through passing of partner process ID fields such as PP1 to PPn as shown in FIG. 6. ECAP 202 uses PP ID fields to establish links for reporting. Partner Processes may use ECA event information to further business functions they perform. For instance, Business Software Application (BSA) 107 will now have ECA information for callers on a per prompt response level. In one example, reporting of ECA information could lead BSA 107 to discovery of a level of stress reported at statistically significant levels in response to a specific prompt or prompt sequence.

Analysis continues until VCP 201 sends a STOP_ANALYSIS message to ECAP 202 or until voice stream data ceases. ECAP 202 completes analysis and post processing. This may consist of any number of communications activities such as sending VCP an ANALYSIS_COMPLETE message containing identification information and ANALYSIS_DATA. This information may be forwarded or stored in various places throughout the system including Business Software Application 107 (BSA) or Expert System Process 203 (ESP) depending upon the specific needs of the application. The VCP process then may use the results in the ANALYSIS_DATA field plus other information from auxiliary processes mentioned (BSA 107, etc.) to perform logical functions leading to further prompt selection/creation or other call processing functions (hang up, transfer, queue, etc.).

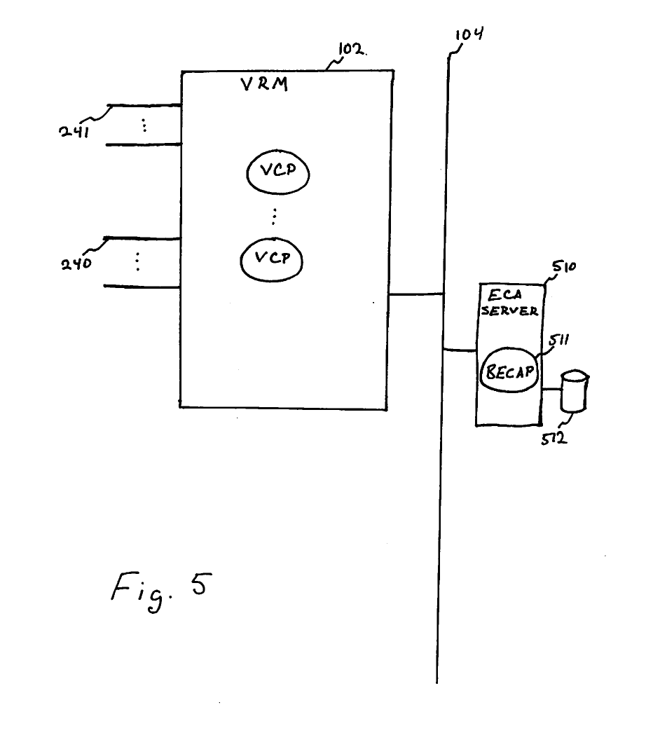

FIG. 5 shows a preferred embodiment of the invention for batch mode operation. For many psychological health diagnostic applications batch mode is sufficient for timely response to subject diagnostic requests. In this embodiment VCP processes record speech as it occurs in call sessions. Call sessions are formed from self-report questionnaires such as PCL-M, PHQ-8, GAD-7, mini-SPIN or other questionnaires designed by psychological professionals. These questionnaires may be modified to encourage open-ended questions since longer responses result in more user voice data for analysis. This pre-questionnaire preparation is an important step in ensuring collection of sufficient data for analysis.

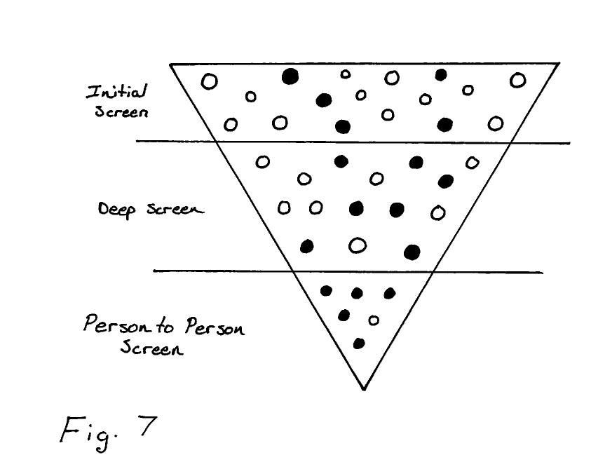

Information contained in a START_ANALYSIS message is stored with audio in a file or in an associated database like database platform (DBP) 421. Periodically, often at night, these files are copied or moved to batch server 510, where they are analyzed by Batch ECA Process 511 (BECAP). This process performs steps as shown for example in FIG. 7. Reporting from BECAP 511 may be to the same type and number of Partner Processes described in the real time scenario described above.

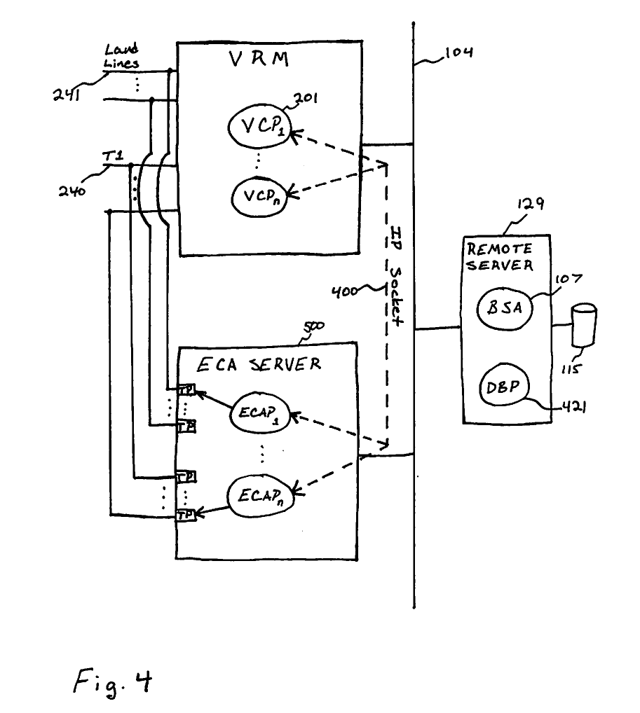

FIG. 4 shows a preferred embodiment of the invention whereby ECAP 202 processes are hosted in a separate server from a VRU. This is sometimes necessary to preserve the software environment of the VRU or to offload processing to another server. In any case, voice stream connectivity is the same and is typically a TCP/IP socket or pipe connection. Other streaming data connectivity technologies known in the art may be substituted for this method. Additionally, direct access to voice data may occur through TP 401 or TP 405 ports in the ECAP 202 for conversion of voice signal from land line or T1 (respectively) to PCM for analysis.

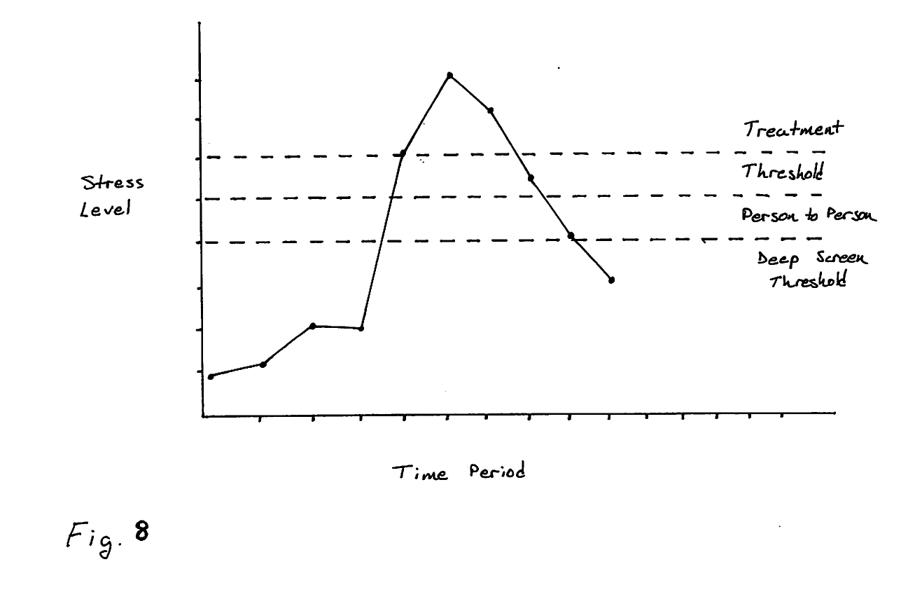

Data collected from analysis of voice in this system is used to implement screens of populations of subjects in a multi-layered regime. Subjects are screened periodically as shown in FIG. 8. Stress levels exceeding a predetermined threshold trigger a request for a deep screen via a generated report from a system database. This screen may include self-report questionnaires listed above or new questionnaires designed by professional psychologists. The subject is now in a smaller population to be screened more closely and perhaps more frequently. Subjects exceeding the next threshold, as identified in a generated report from a system database, are required to escalate to a psychological professional for person-to-person analysis. The invention may be used in this way in a variety of scenarios to reduce cost of paid staff and expand access to screening required to provide appropriate levels of PH treatment.

Once a subject is enrolled in treatment, screening continues as shown in FIG. 8. The subject's stress levels from a plurality of ECA assessments as described above are stored in a multidimensional system database for comparison of multiple results from other diagnostic data sources used in treatment. These may include salivary cortisol levels, heart rate variability, EEG, blood pressure, MEG, fMRI, opinion of staff psychologists and others. Any or all of these additional data or none may be used to build an effective treatment and monitoring regime. The use of this invention in conjunction with these other tools is at the discretion of the professionals implementing treatment. It is however, highly desirable and recommended that ECA screens be continued across any treatment time frame as a way to characterize treatment effectiveness since ECA data acts as a first screen and trigger for deeper screening, etc.

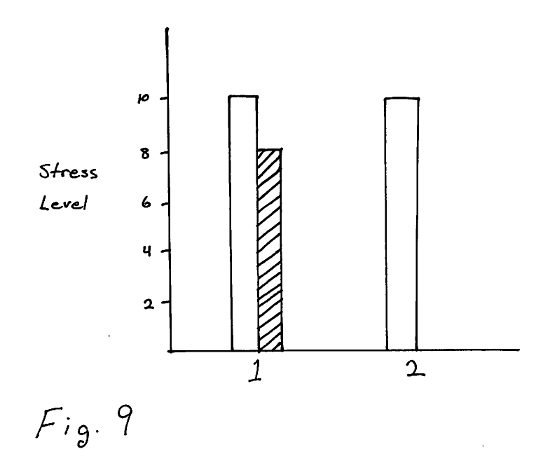

There are many treatment techniques for psychological health disorders. These techniques vary in cost and effectiveness. The invention described herein serves as a tool for evaluation of effectiveness of any treatment and provides a method for comparison to other treatments. FIG. 9 shows stress levels before and after for two treatment types. Treatment 1 results in a reduced overall stress level for a group to 8 from 10. Treatment 2 results in a reduced overall stress level to 5 from 10 for the same or a similar group. In this example treatment 2 is clearly more effective than treatment 1 for the group or type of group. Being able to measure effectiveness of treatments is a powerful tool to ensure adequate care and to reduce costs of treatment. This invention provides a system and method for such comparison and evaluation.

What is claimed is:

1. A system for using emotional content analysis to diagnose psychological health problems, comprising:
apparatus for receiving and processing calls;
apparatus for storing and playing pre-recorded or synthesized prompts and for storing speech responses;
apparatus for interconnecting computers and apparatus for performing emotional content analysis;
wherein the apparatus for storing and playing pre-recorded or synthesized prompts and for storing speech responses is used to administer questionnaires to one or more callers; and
further wherein a set of speech responses collected during the questionnaires is used to automatically generate at least an indicia of psychological health of one or more of the callers.

2. A method for using emotional content analysis to diagnose psychological health problems, comprising the steps of:
(a) routing calls via a network such as a public switched telephony network (PSTN) to an IVR system;
(b) answering calls at the IVR system;
(c) playing one or more audio prompts;
(d) receiving speech from a caller in response to the prompts;
(e) storing the speech in one or more data files;
(f) moving the data files in batch mode to a server hosting emotional content analysis software;
(g) analyzing a portion of a caller's speech using emotional content analysis software to determine at least an indicia of psychological health of the caller; and
(h) creating reports summarizing results from a plurality of psychological health assessments.
